(19) United States
(12) Patent Application Publication
(10) Pub. No.: US 2018/0032815 A1
(43) Pub. Date: Feb. 1, 2018

(54) ELECTRONIC DEVICE AND METHOD FOR IRIS AUTHENTICATION THEREOF

(71) Applicant: Samsung Electronics Co., Ltd., Gyeonggi-do (KR)

(72) Inventors: Woo Yong LEE, Gyeonggi-do (KR); Hye Jin KANG, Gyeonggi-do (KR); Dae Kyu SHIN, Gyeonggi-do (KR); Ju Woan YOO, Gyeonggi-do (KR); Kwang Hyun LEE, Gyeonggi-do (KR); Hee Jun LEE, Seoul (KR); Min Sheok CHOI, Gyeonggi-do (KR); Ji Yoon PARK, Gyeonggi-do (KR); Ki Huk LEE, Gyeonggi-do (KR); Cheol Ho CHEONG, Seoul (KR)

(73) Assignee: Samsung Electronics Co., Ltd.

(21) Appl. No.: 15/659,056

(22) Filed: Jul. 25, 2017

(30) Foreign Application Priority Data
Aug. 1, 2016 (KR) 10-2016-0098222

(51) Int. Cl. G06K 9/00; G06K 9/03

(52) U.S. Cl. CPC G06K 9/00617; G06K 9/00604; G06K 9/0061; G06K 9/036

(57) ABSTRACT

An electronic device is provided. The electronic device includes an iris recognizing unit that extracts an iris area from one frame of a preview image and performs iris authentication by comparing a feature of the iris area with registered iris information and a processor that determines a match, a no-match, or an iris recognition error based on one of an amount of times that the iris authentication is performed during a first time period and a result of the iris authentication during the first critical time period.

### PRIORITY

This application claims priority under 35 U.S.C. §119(a) to Korean Patent Application Serial number 10-2016-0098222, which was filed on Aug. 1, 2016 in the Korean Intellectual Property Office, the entire disclosure of which is incorporated herein by reference.

### BACKGROUND

### 1. Field of the Disclosure

The present disclosure relates, generally, to an electronic device, and more particularly, to an electronic device that uses an iris authentication method.

### 2. Description of the Related Art

Various methods of authenticating a user may be applied to an electronic device. For example, the electronic device may perform user authentication based on a password, a keyword, a pattern, or the like. The electronic device may compare pre-registered authentication information with currently input authentication information. If the comparison result indicates that the pre-registered authentication information is the same as the currently input authentication information, the electronic device may authenticate a user. The electronic device may also perform user authentication by using biometric information (e.g., a fingerprint or an iris) of the user. The electronic device may compare the currently input authentication information with the pre-registered authentication information. If the comparison result indicates that the pre-registered authentication information is the same as the currently input authentication information, the electronic device may authenticate a user.

If a no-match is verified between the currently input authentication information and the pre-registered authentication information a certain number of times during a process of authenticating the user, the electronic device may execute a lock out function restricting the use of the electronic device during a specific time period.

An electronic device that performs biometric authentication (e.g., an iris recognizer) may successively receive biometric data and may perform the user authentication by comparing successively input biometric data with registered biometric data. As such, a biometric authentication system may provide notification of no-match, which occurs a plurality of times within a very short time period, based on the result of comparison of the successively input biometric data with the registered biometric data. If the biometric authentication system counts a certain number of no-matches, as a failure of user authentication, the lock out function may be executed in an excessively short time period.

### SUMMARY

The present disclosure has been made to address at least the disadvantages described above and to provide at least the advantages described below. Accordingly, an aspect of the present disclosure is to provide a biometric authentication system and a method that are capable of distinguishing between no-match and a recognition error in a user authentication process by using biometric information.

In accordance with an aspect of the present disclosure, there is provided an electronic device. The electronic device includes an iris recognizing unit that extracts an iris area from one frame of a preview image and performs iris authentication by comparing a feature of the iris area with registered iris information and a processor that determines a match, a no-match, or an iris recognition error based on one of an amount of times that the iris authentication is performed during a first time period and a result of the iris authentication during the first critical time period.

In accordance with an aspect of the present disclosure, there is provided an iris authentication method. The method includes extracting an iris area from one frame of a preview image, performing iris authentication by comparing a feature of the iris area with registered iris information, determining a match, a no-match, or an iris recognition error based on one of an amount of times that the iris authentication is performed during a first time period and a result of the iris authentication during the first critical time period, and displaying the match, the no-match, or the iris recognition error.

In accordance with an aspect of the present disclosure, there is provided an electronic device. The electronic device includes a housing, a touchscreen display exposed through one surface of the housing, a light source disposed on the one surface of the housing, an imaging device that photographs an iris of a user by using a portion of light, which is emitted from the light source and is reflected from a face of the user, and disposed on the one surface of the housing, a processor electrically connected with the touchscreen display, the light source, and the imaging device, and at least one memory electrically connected with the processor to store a reference iris image. The memory stores instructions that, when executed, cause the processor to allow the light source to emit light, obtain a first plurality of images by using the imaging device during a first time period, while the light is emitted, compare the reference iris image with an object included in the first plurality of images, and count the number of failures of iris authentication as one no-match, if the comparison result indicates that the reference iris image is not the same for the object included in at least two images among the first plurality of images.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating an iris authentication system, according to an embodiment of the present disclosure;

FIG. 2 is a block diagram illustrating an iris recognizing unit, according to an embodiment of the present disclosure;

FIG. 3 is a flowchart illustrating an iris authentication method, according to an embodiment of the present disclosure;

FIG. 4A is a flowchart illustrating an iris authentication method, according to an embodiment of the present disclosure;

FIG. 4B is a diagram for describing an iris authentication method, according to an embodiment of the present disclosure;

FIGS. 5A to 5G are diagrams illustrating a preview image and a guide image, according to an embodiment of the present disclosure;

FIG. 6 is a flowchart illustrating an iris recognition method, according to an embodiment of the present disclosure;

FIG. 7 is a flowchart illustrating an iris authentication method, according to an embodiment of the present disclosure;

FIG. 8 is a flowchart illustrating an iris authentication method, according to an embodiment of the present disclosure;

FIG. 9 is a block diagram illustrating an electronic device in a network environment, according to an embodiment of the present disclosure;

FIG. 10 is a block diagram of an electronic device, according to an embodiment of the present disclosure; and

FIG. 11 is a block diagram illustrating a program module, according to an embodiment of the present disclosure.

Throughout the drawings, it should be noted that like reference numbers are used to depict the same or similar elements, features, and structures.

### DETAILED DESCRIPTION

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. For example, a first element may be referred to as a second element without departing from the scope the present invention, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a CPU or an application processor) capable of performing a corresponding operation by executing one or more software programs stored in a memory device.

The terms used in describing the various embodiments of the present disclosure are for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present invention may include at least one of an application-specific integrated circuit (ASIC) chip, a field-programmable gate arrays (FPGA), and a programmable-logic device for performing operations which has been known or are to be developed hereinafter.

An electronic device according to the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

The electronic device may be a home appliance. The home appliance may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

The electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics, security devices, an automotive head unit, a robot for home or industry, an automatic teller machine (ATM) in banks, point of sales (POS) devices in a shop, or an Internet of Things (IoT) device (e.g., a light bulb, various sensors, electric or gas meter, a sprinkler device, a fire alarm, a thermostat, a streetlamp, a toaster, a sporting goods, a hot water tank, a heater, a boiler, etc.).

The electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may also be a flexible device. Further, the electronic device is not limited to the aforementioned devices, and may include an electronic device according to the development of new technology.

Hereinafter, an electronic device will be described with reference to the accompanying drawings. In the present disclosure, the term “user” may indicate a person using an electronic device or a device (e.g., an artificial intelligence electronic device) using an electronic device.

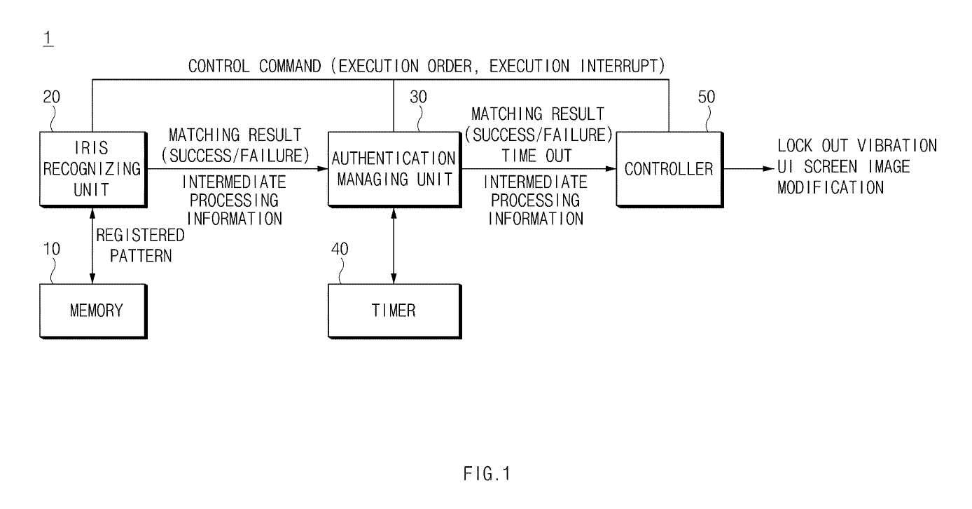

FIG. 1 is a block diagram illustrating an iris authentication system, according to an embodiment of the present disclosure.

As illustrated in FIG. 1, an iris authentication system 1 includes a memory 10, an iris recognizing unit 20, an authentication managing unit 30, a timer 40, and/or a controller 50. At least one (e.g., the memory 10 or the authentication managing unit 30) of the memory 10, the iris recognizing unit 20, the authentication managing unit 30, the timer 40, and/or the controller 50 may be omitted in the iris authentication system 1. Components included in the iris authentication system 1 may be included in different electronic devices. For example, the memory 10, the authentication managing unit 30 may be included in a server, and the iris recognizing unit 20 may be included in a mobile terminal. The iris recognizing unit 20, the authentication managing unit 30, the timer 40, and/or the controller 50 may be included in at least one processor. Each of the iris recognizing unit 20, the authentication managing unit 30, the timer 40, and/or the controller 50 may be a separate hardware module, or may be a software module implemented by at least one processor. The function of each of modules included in the processor may be performed by one processor or may be performed by separate processors. The processor may be implemented with a system on chip (SoC) that includes at least one central processing unit (CPU), a graphic processing unit (GPU), a memory, and the like.

The memory 10 may store information for authentication that is necessary for iris authentication. The information for authentication may be a registration pattern, a recognition time, first and second critical times, or the like.

The iris recognizing unit 20 may extract an iris feature from at least one frame of a preview image and may compare the extracted iris feature with registered iris information through pattern matching. The iris recognizing unit 20 may detect the iris feature by using an iris image, of which the quality is the best, from among iris images detected during a specified recognition time period. When performing image processing on the image frame, the iris recognizing unit 20 may determine whether a biometric eye image is included in a specified eye area, and may use the biometric eye image, which is not tampered with (or damaged), to extract the iris feature.

If the extracted iris feature is the same as the registered iris information, the iris recognizing unit 20 may output information indicating a match. If the extracted iris feature is not the same as the registered iris information, the iris recognizing unit 20 may output information indicating a no-match. The iris recognizing unit 20 may feedback intermediate processing information about a failure of detection of a specific area, spoofing, quality degradation, and the like to the authentication managing unit 30 in a process of recognizing an iris.

The timer 40 may be driven and may measure a time, under control of the authentication managing unit 30. The timer 40 may be included in the authentication managing unit 30.

The authentication managing unit 30 may determine one match or no-match by using a plurality of authentication results of the iris recognizing unit 20 during a first critical time period. The first critical time period may be set to a time period (e.g., 9 seconds), which can be shorter than the time when eyes of the user is capable of being damaged by the infrared light emitted for iris recognition.

The authentication managing unit 30 may receive intermediate processing information from the iris recognizing unit 20 and may distinguish between an iris recognition error and no-match by using the intermediate processing information. The iris recognition error may occur in the case where at least one of a face area, an eye area, a pupil area, and an iris area is not detected from the image frame.

If verifying that an iris is not recognized by the iris recognizing unit 20 by using the intermediate processing information within a second critical time period, the authentication managing unit 30 may notify the controller 50 of authentication time out. The second critical time period may be an expiration time of one iris authentication, and may be the same as the first critical time period or may be set differently from the first critical time period.

If receiving a request of iris authentication from an application, the controller 50 may perform iris authentication by driving the iris recognizing unit 20 and the authentication managing unit 30. The application may be a program that uses the iris authentication for user authentication, such as an Internet banking application. The controller 50 may receive authentication result information, iris recognition error information, and the intermediate processing information from the authentication managing unit 30, and may verify an authentication process, an authentication result, and a recognition error. The controller 50 may output a user interface corresponding to the verified authentication process, authentication result, and recognition error.

If verifying the iris recognition error in the intermediate processing information received from the iris recognizing unit 20, the controller 50 may notify the user of the iris recognition error in at least one manner of vibration and a user interface (UI or UX) screen. If verifying that one iris recognition error occurs during the first critical time period in the intermediate processing information, the controller 50 may blur a remaining area other than an eye area of a preview image. The controller 50 may provide notification of the iris recognition error in at least one manner of motor vibration and outputting of a recognition error text. If verifying that the iris recognition error occurs a plurality of times during the second critical time period in the intermediate processing information, the controller 50 may output the user interface for providing notification of the iris recognition error that occurs a plurality of times. The controller 50 may enhance the blurring of the preview image and the intensity of the motor vibration depending on the number of times of occurrences of informing the iris recognition error.

The controller 50 may output at least one of a preview image, a guide image, and a graphic object image in at least a part or portion of a display during the iris authentication. The controller 50 may process or compose at least one of the preview image, the guide image, and the graphic image, and output the image. The controller 50 may overlay the guide image or a graphic object image on the preview image and may output the overlaid image.

The controller 50 may output a guide message for the iris authentication process, and for providing notification of a match, time out, a no-match, a lock out, and the like of the iris authentication process.

The controller 50 may execute an operation for at least one of blurring, color conversion, brightness adjustment, and brightness correction, to reduce the resistance of the user to the preview image.

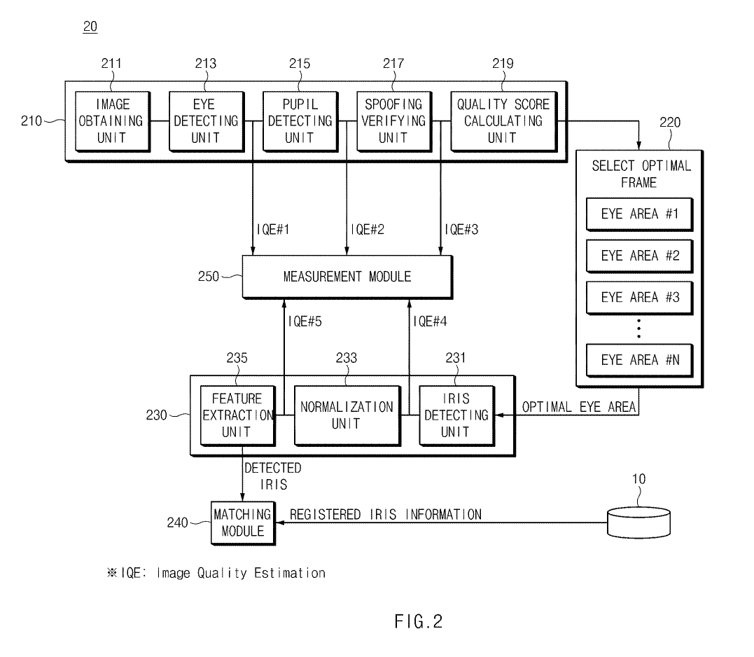

FIG. 2 is a block diagram illustrating an iris recognizing unit, according to an embodiment of the present disclosure.

The iris recognizing unit 20 may include at least one of a detection module 210, a selection module 220, an extraction module 230, a matching module 240, and/or a measurement module 250.

The detection module 210 may detect an iris image from each image frame. The detection module 210 may include an image obtaining unit 211, an eye detecting unit 213, a pupil detecting unit 215, a spoofing verifying unit 217, and a quality score calculating unit 219.

The image obtaining unit 211 may obtain each image frame of a preview image (or a photographed image) from a camera. The image obtaining unit 211 may obtain a plurality of image frames (e.g., 15 frames) per second.

The eye detecting unit 213 may detect an eye area from each image frame. The eye detecting unit 213 may detect a face area from an image frame based on a value of a face feature by using a face feature including at least one of an eye, a mouth, or a nose, and may detect the eye area from the face area by using a specified algorithm. The specified algorithm may include at least one of adaboost eye detector, rapid eye, camshift, speeded up robust feature (SURF), binarization, labeling, and the like. The eye detecting unit 213 may transmit information IQE#1 about whether the eye area is obtained and the image quality (e.g., a shake or a focus) of the eye area to the measurement module 250.

The pupil detecting unit 215 may detect a pupil in the eye area. The pupil detecting unit 215 may distinguish between the eye and the peripheral area in the eye area through a known technology, and may detect the pupil area from the eye area. The pupil detecting unit 215 may transmit information IQE#2 about whether the pupil area is obtained and the image quality (e.g., a shake or a focus) of the pupil area to the measurement module 250.

The spoofing verifying unit 217 may determine whether the biometric eye image is included in the eye area, by executing a set anti-spoofing function.

The spoofing verifying unit 217 may change each pixel value of the eye area into a value of a frequency domain and may determine whether the detected eye image is tampered with (or damaged), based on whether the distribution of the value on the frequency domain is within a set critical range. The critical range may be determined by using a frequency value of at least part (e.g., a pupil area) of a plurality of user's eye areas. As the eyelid texture and an eye texture of the user are different from each other, there is a difference in the texture between an image obtained by photographing a biometric iris and an image obtained by photographing the printed iris. The difference in the texture may be due to the frequency difference in the pixel value of the photographed image. As such, whether the eye image to be used for iris authentication is tampered with may be determined by using the frequency value of the eye area.

The spoofing verifying unit 217 may determine whether the eye image is the biometric eye image, based on the distribution of brightness information of the eye area. The variance value of brightness distribution of the eye area on the printed image may be relatively less than that of the biometric eye image. As such, the spoofing verifying unit 217 may distinguish between the biometric eye image and the printed eye image by determining whether the variance value of brightness distribution of the eye area is within the set critical range. The critical range may be experimentally determined from the average brightness distribution of a plurality of biometric eye images.

The spoofing verifying unit 217 may transmit information IQE#3 about whether a spoofing verification test is passed, to the measurement module 250.

The quality score calculating unit 219 may calculate the quality score of the eye area by using at least one of image acquisition, the eye area, a result of detecting the pupil area, and a spoofing verification result. The quality score calculating unit 219 may calculate the quality score of the eye area by applying a score corresponding to each processing result (detection success or failure). The quality score calculating unit 219 may assign a relatively low score to the image verified to be tampered with. The quality score calculating unit 219 may also calculate the quality score of each eye image by using the image quality score calculated by the measurement module 250.

The selection module 220 may output the eye image, which has the highest quality, from among the eye images (or images of the eye areas) input based on the quality score calculated by the quality score calculating unit 219 during the recognition time period set. The recognition time period may be less than or equal to the first critical time period.

The extraction module 230 may include an iris detecting unit 231, a normalization unit 233, and a feature extraction unit 235. Hereinafter, each of elements of the extraction module 230 will be described.

The iris detecting unit 231 may segment an iris area from the eye area. The iris detecting unit 231 may detect the iris area from the eye area by using a circular edge detector that is based on a reference iris size. For example, the reference iris size may be selected based on at least one of a width of the face of the user, a distance between both eyes, and a photographed iris size for each photographing distance. The iris detecting unit 231 may transmit information IQE#4 about whether the iris area is obtained and the image quality (e.g., a shake or a focus) of the iris area to the measurement module 250.

The iris detecting unit 231 may perform at least one of noise filtering, brightness/color correction, contrast, smoothing, binarization, blurring, removing of illumination effect, sharpening, thinning, edge extraction, or boundary following on the iris area.

The normalization unit 233 may normalize the iris area by changing the size, shape, orientation, or the like of the iris area depending on the set reference. The set reference may be set to correspond to registered iris information. The normalization unit 233 may transmit information IQE#5 about the result of processing normalization to the measurement module 250. The information about the result of processing normalization may include at least one of a size, a shape, an orientation, or the like of the iris area.

The feature extraction unit 235 may extract iris feature information from the normalized iris area. The iris feature information may include at least one of the feature points of an iris and an iris pattern.

The matching module 240 may determine whether the extracted iris feature is the same as the iris feature registered in the memory 10 through pattern matching. The matching module 240 may output the authentication result, for example, information about a match or a no-match.

The measurement module 250 may receive information IQE#1, IQE#2, IQE#3, IQE#4 and IQE#5 received from the eye detecting unit 213, the pupil detecting unit 215, the spoofing verifying unit 217, the iris detecting unit 231, and the normalization unit 233 and may measure image quality. The measurement module 250 may determine whether detection of a main area succeeds, based on the received information IQE#1, IQE#2, IQE#3, IQE#4 and IQE#5. The main area may be the eye area, the pupil area, and the iris area. The measurement module 250 may calculate the image quality score based on attribute information of the main area. The attribute information may be at least one of the size, shape, arrangement, angle, and color of the detected main area. If the total number of pixels of the eye area is less than the critical number (e.g., 100 pixels in each of the horizontal and vertical directions), the measurement module 250 may determine that the image quality is not good. If a ratio of the eye area to the whole face area is not greater than a specific ratio (e.g., not greater than 10% of a vertical face length), the measurement module 250 may determine that the image quality is low. If the relative location of the eye area deviates from the candidate area (e.g., within 70% of the total angle of view with respect to the center), the measurement module 250 may determine that the image quality is low.

The measurement module 250 may determine the image quality based on at least one of the brightness or color distribution of the whole image. If the image is a dark image, the measurement module 250 may determine that the image quality is low. If the average illuminance of the image is less than the set critical illuminance (e.g., 30% of the maximum brightness), the measurement module 250 may determine that the image quality is low. If the brightness distribution of the image is less than the set reference distribution (e.g., the difference between the maximum brightness and the minimum brightness is 10%), the measurement module 250 may determine that the image quality is low.

The measurement module 250 may determine the image quality based on the AC component in the image. If the AC component in the image is within a specific AC range (e.g., a specific frequency range obtained by analyzing spatial frequency of the image), the measurement module 250 may determine that there is a large amount of white noise.

The measurement module 250 may measure the image quality by using a signal to noise ratio (SNR). In the case where the SNR of the image is not greater than 20 dB, the measurement module 250 may determine that the image quality is low.

If it is verified that the motion in the differential image for the continuous images is not less than the reference motion, the measurement module 250 may determine that the image quality is low. The measurement module 250 may extract the optical flow of the image. If the extracted optical flow has a motion vector of a specific value or more, the measurement module 250 may determine that the image quality is bad.

In the case where the photographing time period of each image exceeds a specified time period (e.g., 1 sec) in the authentication process, the measurement module 250 may determine that the image quality is low.

The measurement module 250 may estimate the sharpness of the image based on the focus information or the focus variation information of the camera. If the sharpness of the image is less than the specified sharpness, the measurement module 250 may determine that the image quality is low.

The image quality measured by the measurement module 250 may be included in intermediate processing information, and the intermediate processing information may be transmitted to the controller 50. The controller 50 may output the screen associated with the quality of the iris image by using the intermediate process information.

The intermediate processing information of the eye detecting unit 213, the pupil detecting unit 215, the spoofing verifying unit 217, the quality score calculating unit 219, the iris detecting unit 231, and/or the normalization unit 233 may be transmitted to the controller 50. The intermediate processing information may include at least one of whether an eye is detected, whether a pupil is detected, whether an image is tampered with (or damaged), whether an iris is detected, whether normalization succeeds, and image quality.

The spoofing verifying unit 217 may determine whether the spoofing occurs, through at least one of recognition of the speaker, verifying of a password, proximity sensing, measurement of a heart rate, and verifying of a user input corresponding to a set command. The spoofing verifying unit 217 may perform spoofing verification before the iris recognition or may perform spoofing verification independently of the iris recognition. The spoofing verifying unit 217 may be included independently of the iris recognizing unit 20.

Since the image quality is verified in an iris recognition process or intermediate processing information of a recognition process is provided, the basis for distinguishing between an iris recognition error and an iris recognition result may be provided.

The amount of computation for extracting the iris feature may be reduced by selecting an optimal frame from a plurality of image frames and by detecting the iris feature using the selected frame.

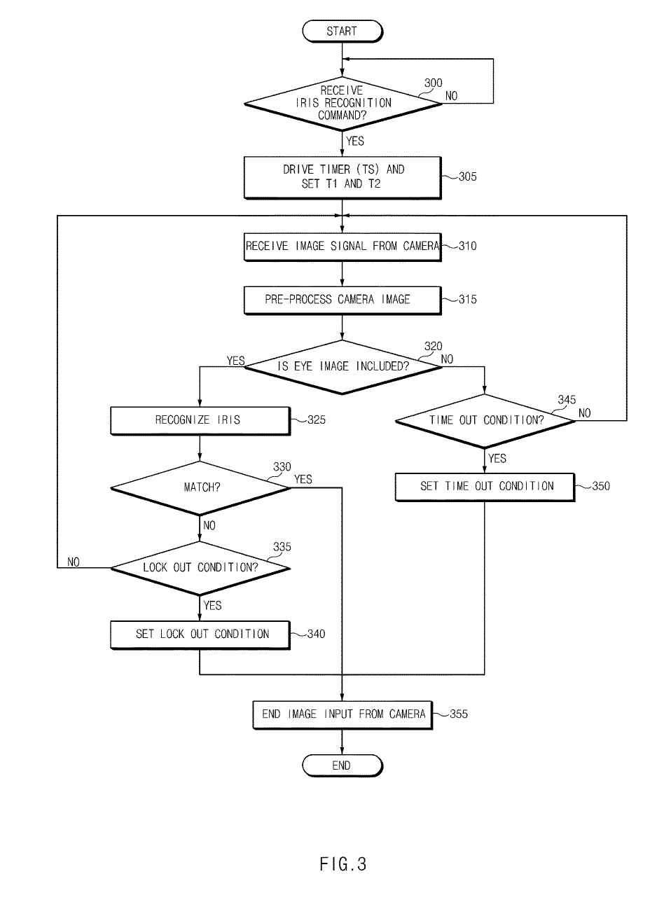

FIG. 3 is a flowchart illustrating an iris authentication method, according to an embodiment of the present disclosure.

Referring to FIG. 3, in operation 300, the iris authentication system 1 may receive an iris recognition command. Operation 300 may be executed by the iris recognizing unit 20, the authentication managing unit 30, or the controller 50.

In operation 305, the iris authentication system 1 may drive the timer 40 at a time Ts, and may set first and second critical time periods T1 and T2. In operation 305, the iris authentication system 1 may drive the timer 40 in synchronization with at least one of a point in time when the iris authentication command is received, a point in time when a camera is driven, a point in time when emitted infrared light is turned on during the iris recognition, and a point in time when the turned-on infrared light is stabilized. Operation 305 may be executed by the authentication managing unit 30 or the controller 50.

The first critical time period T1 may be a time period in which one iris authentication expires, and may be set in consideration of the intensity of the infrared LED or the value of the depth sensor. The first critical time period T1 may be the maximum time during which eyes of the user are not damaged when continuously exposed to the output from an infrared light emitting diode (LED). The first critical time period T1 may be set to 10 seconds at a distance of 10 cm in an infrared LED having an intensity of 10 W/m². Where a result of analyzing the value of the depth sensor indicates that the subject is far away, the first critical time period T1 may be set to be longer. The second critical time period T2 may be a time period in which one iris authentication expires, and may be set to be the same as the first critical time period T1 or may be set to be longer than the first critical time period T1. Where the sensing result by the illuminance sensor indicates that the illuminance around the terminal is low, the second critical time period T2 may be set to be longer than the case where the sensing result by the illuminance sensor indicates that the illuminance around the terminal is not low.

In operation 310 to operation 315, the iris authentication system 1 may receive an image frame from a camera and may pre-process the received image frame. The iris authentication system 1 may perform pre-processing to extract the eye area from each image frame by using a known algorithm.

In operation 320 the iris authentication system 1 may determine whether the eye image is included in the eye area, by using the pixel contrast of the eye area. If the iris authentication system 1 verifies that at least one eye image is included in the eye area within the recognition limit time period, the iris authentication system 1 may determine that the eye image is included in the eye area. If the iris authentication system 1 verifies that an image of at least two eyes is included in the eye area within the recognition limit time period, the iris authentication system 1 may determine that the eye image is included in the eye area.

In operation 325, if the eye image is included in the eye area, the iris authentication system 1 may recognize an iris in the eye area. The iris authentication system 1 may segment an iris area from the eye area and may extract an iris feature after normalization based on the reference. Operation 310 to operation 325 may be executed by the iris recognizing unit 20.

In operation 330, the iris authentication system 1 may determine whether the iris authentication succeeds, by using the result of pattern matching during the first critical time period. If verifying at least one match during the first critical time period T1, the iris authentication system 1 may determine that the iris authentication succeeds. In other words, if verifying that a time period Tc−Ts of an iris authentication is less than a first critical time period, the iris authentication system 1 may determine that the iris authentication succeeds. Tc may be the current time, and Ts may be the driving time point of the timer 40. Operation 330 may be executed by the authentication managing unit 30. If verifying at least one no-match in a state where there is no successfully verified iris authentication during the first critical time period, the iris authentication system 1 may determine that the iris authentication fails. As such, the iris authentication system 1 may count no-matches, which occurs a plurality of times within the first critical time period, as one no-match. The iris authentication system 1 may drive the timer 40 at a first reference time point Ts₁ to perform the first iris authentication process. Since the iris authentication system 1 verifies no-match (e.g., five times), which is without authentication success, at the first reference time point Ts₁ during the first critical time period T1, the iris authentication system 1 may count the no-match as the first no-match. The iris authentication system 1 may drive the timer 40 at a second reference time point Ts₂ to perform the second iris authentication process. Since the iris authentication system 1 verifies only the no-match (e.g., five times), which is without authentication success, during the first critical time period T1, the iris authentication system 1 may count the no-match as the second no-match. Even though the iris recognizing unit 20 notifies the authentication managing unit 30 of the no-match occurring ten times in total, the authentication managing unit 30 may count the no-match as no-match that occurs twice in total. As such, it is possible to prevent the authentication system 1 from being locked out in an extremely short time period.

In operation 335, if verifying that the iris authentication fails, the iris authentication system 1 may determine whether a lock out condition is satisfied. The iris authentication system 1 may determine whether the accumulated number of no-matches is the same as the set critical number (e.g., three times). If the accumulated number is the same as the critical number, the iris authentication system 1 may determine that a lock out condition is satisfied. If verifying the match when the accumulated number of no-matches is less than the critical number, the iris authentication system 1 may initialize the accumulated number. The accumulated number of no-matches may be the number of no-matches transmitted from the authentication managing unit 30 to the controller 50. If the ratio of the number of no-matches to the total number of authentication attempts is not less than the critical ratio, the iris authentication system 1 may determine that the lock out condition is satisfied. If the ratio of the number of no-matches to the number of authentication attempts during a specific time period is not less than the critical ratio, the iris authentication system 1 may determine that the lock out condition is satisfied.

In operation 340, if verifying that the lock out condition is satisfied, the iris authentication system 1 may execute a lock out function. The lock out function may be a function to prevent an electronic device, to which the iris authentication system 1 is applied, from being used for a set limit time period. Operation 335 to operation 340 may be executed by the controller 50.

In operation 345, if an eye image is not included in an eye area, the iris authentication system 1 may determine that a time out condition is satisfied. If the elapsed time Tc−Ts of the timer 40 exceeds the second critical time period T2 while the iris authentication system 1 does not detect the eye image from the image frame, the iris authentication system 1 may determine that the time out condition is satisfied. Whenever the time out condition is satisfied, the iris authentication system 1 may increase the accumulated number of the time out by one. Where the time out condition is satisfied, the iris authentication system 1 may not count the no-match as no-match corresponding to a lock out condition.

In operation 350, if the time out condition is satisfied, the iris authentication system 1 may set time out. If the time out condition is satisfied, the iris authentication system 1 may display time out information. In operation 345 and operation 350, if verifying that the time out condition is satisfied, from the authentication managing unit 30, the controller 50 may interrupt one iris recognition and may display the time out information.

In operation 355, the iris authentication system 1 may end the input of a preview image from a camera to the iris recognizing unit 20 upon a time point of the match, the time out, and setting of the lock out. Operation 355 may be executed by the controller 50.

The methods described herein provide information to the user by distinguishing between the case where the eye or the iris itself is not recognized in the image frame and the case where the iris authentication fails in the iris authentication.

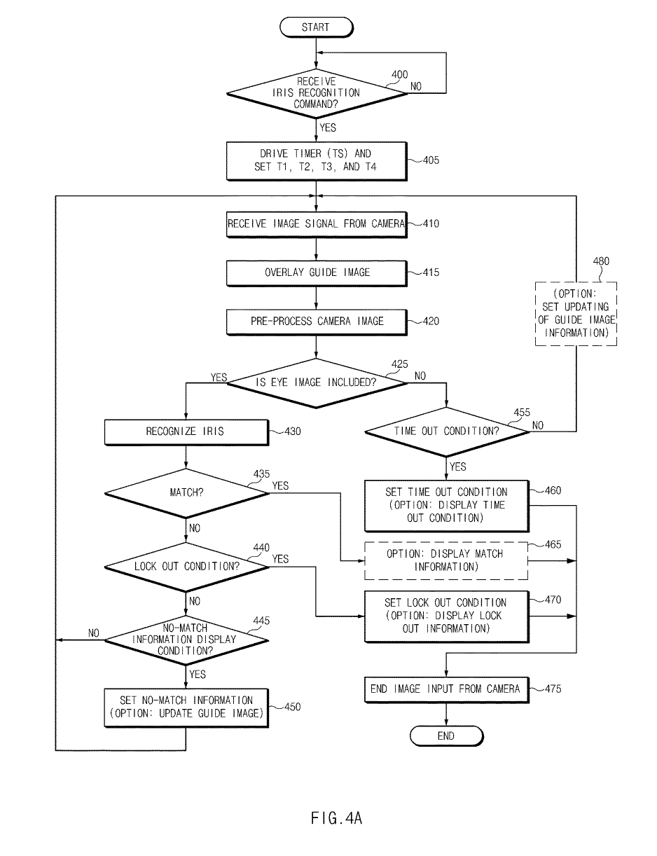

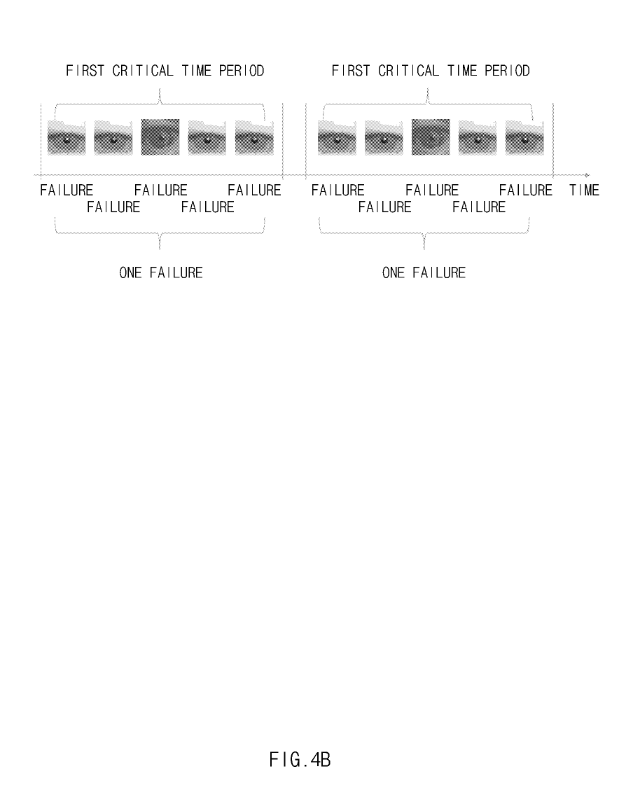

FIG. 4A is a flowchart illustrating an iris authentication method, according to an embodiment of the present disclosure. FIG. 4B is a diagram for describing an iris authentication method, according to an embodiment of the present disclosure.

Referring to FIG. 4A, in operation 400, the iris authentication system 1 may receive (or verify) an iris recognition command input by a user.

In operation 405, the iris authentication system 1 may drive the timer 40 that verifies a lock out condition or a time out condition. In operation 405, the iris authentication system 1 may set at least one of first to fourth critical time periods T1, T2, T3, and T4. Each of the third and fourth critical time periods may be a critical time period for providing a UI. The iris authentication system 1 may output ae UI screen whenever the third critical time period (n*3) set after the reference time point Ts expires. The iris authentication system 1 may provide a first guide image when the third critical time period after the reference time point Ts expires and may provide a second guide image when a fourth critical time period after a driving time point Ts expires.

In operation 410, the iris authentication system 1 may receive an image signal, e.g., each image frame of a preview image, from a camera to recognize an iris.

In operation 415, the iris authentication system 1 may overlay a guide image on the received preview image and may output the overlaid guide image. In operation 415, the iris authentication system 1 may further provide a motor vibration output. Operation 415 may be executed by the controller 50.

In operation 420, the iris authentication system 1 may pre-process each image frame to extract an eye area.

In operation 425, the iris authentication system 1 may determine whether the eye image is included in the eye area. The iris authentication system 1 may determine whether the eye image is included in the eye area, by using the contrast of the eye area.

In operation 430, the iris authentication system 1 may recognize an iris in the eye area. The iris authentication system 1 may segment an iris area from the eye area and may extract an iris feature after normalization. The iris authentication system 1 may compare the extracted iris feature and the registered iris feature. If the comparison result indicates that the extracted iris feature is the same as the registered iris feature, the iris authentication system 1 may determine that iris authentication succeeds.

In operation 435, the iris authentication system 1 may determine whether the iris authentication succeeds, by using the result of pattern matching by the iris recognizing unit 20 during the first critical time period. In operation 435, the iris authentication system 1 may count no-match, which occurs a plurality of times within the first critical time period, as one no-match.

Referring to FIG. 4B, the iris authentication system 1 may drive the timer 40 at a first reference time point Ts₁ to perform the first iris authentication process. If the iris authentication system 1 verifies no-match of the specified number of times (e.g., five times), which is without authentication success from the first reference time point Ts₁ within the first critical time period T1, the iris authentication system 1 may count the no-match, as the first no-match. The iris authentication system 1 may drive the timer 40 at a second reference time point Ts₂ to perform the second iris authentication process. If the iris authentication system 1 verifies only the no-match of the specified number of times (e.g., five times) that is without authentication success from the second reference time point within the first critical time period T1, the iris authentication system 1 may count the no-match, as the second no-match. As illustrated in FIG. 4B, the authentication managing unit 30 receives information indicating the no-match, which occurs ten times in total, from the iris recognizing unit 20, but the authentication managing unit 30 may count the no-match as no-match, which occurs twice in total, based on the corresponding information; it is possible to prevent an electronic device from being locked out in an extremely short time period.

In operation 440, if verifying that the iris authentication fails, the iris authentication system 1 may determine whether a lock out condition is satisfied. For example, if an execution time period Tc−Ts of operation 440 is not less than a first critical time period T1, the iris authentication system 1 may determine that the lock out condition is satisfied. If the execution time period is measured from a reference time (Ts=0), the iris authentication system 1 may determine whether a current time Tc is after the first critical time period T1 expires. The execution time period Tc−Ts of operation 440 is not less than a fourth critical time period T4, the iris authentication system 1 may determine that the lock out condition is satisfied.

In operation 445, if the lock out condition is not satisfied, the iris authentication system 1 may determine whether a display condition of no-match information is satisfied. If a condition of “(Ts+(T3−Tr)≦Tc≦Ts+(T3+Tr)” is satisfied, the iris authentication system 1 may output the no-match information or a guide image. Here, Tc is a current time, Ts is a reference time point, T3 is the third critical time period, and Tr is a specific time. The current time with respect to the reference time point may be a time measured from a reference time point. If a condition “(Ts+(n*T3−Tr))≦Tc≦(Ts+(n*T3+Tr))” is satisfied, the iris authentication system 1 may output the no-match information or a guide image. Here, Tc is a current time, Ts is a reference time point, T3 is the third critical time period, Tr is a specific time, and ‘n’ is an integer. For example, the reference time point Ts may be zero.

In operation 450, if the display condition of no-match is satisfied, the iris authentication system 1 may set the no-match information. The iris authentication system 1 may count and store the accumulated number of no-matches. In operation 450, the iris authentication system 1 may output a guide image, which is the same as the guide image of operation 415, or a guide image corresponding to no-match information based on the accumulated number of counted no-matches.

In operation 455, if a biometric eye image is not included in the eye area, the iris authentication system 1 may determine whether the time out condition is satisfied. If the elapsed time period Tc−Ts is not less than the second critical time period T2, the iris authentication system 1 may determine that the lock out condition is satisfied. If the elapsed time period is not less than the third critical time period or the fourth critical time period, the iris authentication system 1 may determine that the lock out condition is satisfied.

In operation 460, if the time out condition is satisfied, the iris authentication system 1 may set time out. If the time out is set, the iris authentication system 1 may display time out information in a display.

In operation 465, if verifying the match, the iris authentication system 1 may output information about iris authentication success as a UI screen to a display, and operation 465 may be skipped.

In operation 470, if the lock out condition is satisfied, the iris authentication system 1 may execute a lock out function. In operation 470, the iris authentication system 1 may output the lock out information to the display.

In operation 475, the iris authentication system 1 may end the transmission of an image from a camera to the iris recognizing unit 20 upon a time point of iris authentication success, the time out, and setting of the lock out.

In operation 480, if the time out condition is not satisfied, the iris authentication system 1 may update and output the guide image. For example, if Equation (1):

Ts+(T5−Tr)≦Tc≦Ts+(T5+Tr),T5*n+Tr<T1 (1)

is satisfied, the iris authentication system 1 may update a guide image. Here, Tc is a current time, Ts is a reference time point, T5 is the fifth critical time period, and Tr is a specific time. The sum of a multiple of the fifth critical time period and the specific time Tr may be less than the second critical time period. If verifying an iris recognition error once within the first critical time period, the iris authentication system 1 may output the guide image for performing at least one of processing of blurring on the whole area or the remaining area other than an eye periphery of a preview image and outputting vibration.

For example, if Equation (2):

Ts+(T5*n)−Tr≦Tc≦Ts+(T5*n)+Tr,T5*n+Tr<T1 (2)

is satisfied, the iris authentication system 1 may output a guide image. Here, Tc is a current time, Ts is a reference time point, T5 is the fifth critical time period, Tr is a specific time, and ‘n’ is an integer. According to an embodiment, if verifying the iris recognition error a plurality of times within the first critical time period, the iris authentication system 1 may output the guide image indicating an optimal eye location.

In operation 480, when verifying the iris authentication error, the iris authentication system 1 may output the same guide image regardless of the number of authentication errors. The iris authentication system 1 may output the guide image that varies depending on the number ‘n’ of iris authentication errors. If a current time is within a specific time interval after the update of the immediately preceding guide image, the iris authentication system 1 may skip outputting of the guide image.

The iris authentication system 1 may vibrate a motor or display a UI screen (a guide image) to distinguish between the iris recognition error and the iris authentication failure during the iris recognition and authentication process.

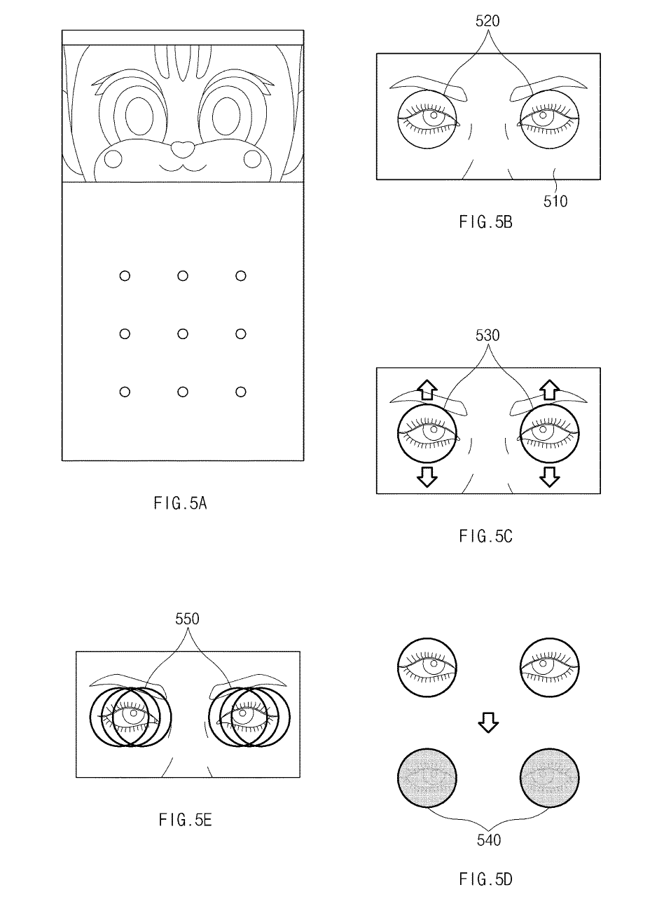

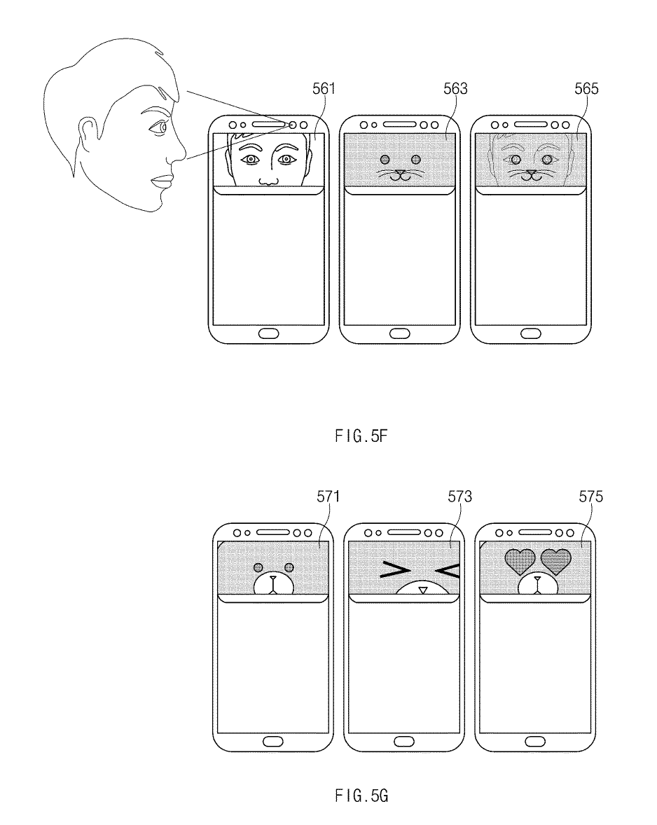

Hereinafter, a preview image, a guide image, and a graphic object image will be described with reference to FIGS. 5A to 5G, which are diagrams illustrating a screen including a preview image, a guide image, and a graphic object, according to an embodiment of the present disclosure.

The iris authentication system 1 may output a preview image including an eye area in the face of a user during iris recognition. The iris authentication system 1 may process the preview image and may output the processed preview image to the user. The preview image may be displayed in at least part of the locked screen of a terminal to which the iris authentication system 1 is applied.

A value of ‘Y’ (10 bits, 1024 colors) may be in the image photographed by an infrared light camera. If converting the value of ‘Y’ into a preview image (8 bits, 256 colors), noise may occur by the contrast of black and white, and the image may be blurry, such as a contour line. However, the iris authentication system 1 may process and output a preview image, thereby improving occurrence of a noise and image blurring.

The iris authentication system 1 may perform the blurring on the whole preview image and may output the blurred preview image to the display. As such, the iris authentication system 1 may improve on (or decrease) the noise, which is caused by the contrast of black and white, with respect to the preview image. The iris authentication system 1 may classify each of pixels of the converted image frame into the darkest pixels (a first step), the intermediate brightness pixels (a second step) and the brightest pixels (a third step), depending on the brightness with respect to two critical brightness. The iris authentication system 1 may convert pixels of first to third steps into three color values, respectively. The iris authentication system 1 may output a preview image composed the three color values in a display. As such, the iris authentication system 1 may improve burring of the preview image. The iris authentication system 1 may convert pixels of the first step into a first color of the darkest, may convert pixels of the second step into the first color of the middle brightness, and may convert pixels of the third step into the first color of the brightest; the first color may be gray, brown, or the like.

The iris authentication system 1 may process and output a pupil area displayed in white in a preview image photographed by an infrared camera. The iris authentication system 1 may tone down and output the contrast of the pupil in the preview image, which is similar to the contrast of the eye pupil of the user. The resistance of the user with respect to the preview image may be reduced by processing the pupil image expressed differently from the actual pupil due to the characteristics of the infrared camera, such that the pupil image appears to be similar to an image of the actual pupil.

The iris authentication system 1 may normalize the brightness of the preview image to some extent in correspondence to the distance from the user and may output the normalized brightness of the preview image to the display. The iris authentication system 1 may detect the distance from the user by the proximity sensor and may normalize the brightness of the preview image by multiplying each pixel value of the preview image by the normalization variable corresponding to the sensed distance. The normalization variable may be experimentally determined to reduce the brightness variation according to the distance from the user. As such, since the photographed image of the infrared camera becomes brighter when the infrared camera is closer to the user, and becomes darker when the infrared camera is further away from the user, it may be difficult to recognize the shape of the photographed object included in the preview image.

The iris authentication system 1 may display a masking image on the preview image, thereby reducing the resistance of the user with respect to the preview image. As illustrated in FIG. 5A, the masking image may be a character image, may be an object image, and may be designated by the user.

The iris authentication system 1 may blur the remaining area other than an eye area in the preview image and may reduce the resistance of the user with respect to the preview image.

The iris authentication system 1 may provide notification of at least one information of an eye detection failure, a pupil detection failure, an iris detection failure, a focal length adjustment necessity, a terminal shake, a brightness adjustment necessity, and a low image quality. When the at least one information is provided, the iris authentication system 1 may output a guide image for assisting the iris authentication process.

As illustrated in FIG. 5B, the iris authentication system 1 may overlay a guide image 510 for displaying an area suitable for the iris recognition on the preview image such that the user places the eye area in an area suitable for the iris recognition of the camera. The iris authentication system 1 may output the overlaid guide image 510.

As illustrated in FIG. 5C, where the detection of the iris fails because the eyelid of the user covers the iris, the iris authentication system 1 may output a guide image for guiding the opening of the eye of the user. A guide image 530 may include an arrow for guiding the opening of the eye of the user.

As illustrated in FIG. 5D, the iris authentication system 1 may output a guide image 540, in which the eye area is blurred on the preview image, to indicate that the focal distance of the camera is not matched.

As illustrated in FIG. 5E, the iris authentication system 1 may output a guide image 550 indicating that the eye area detected from the image frame is changed due to the camera shake.

The iris authentication system 1 may sense the acceleration of each of the x, y, and z-axes by an acceleration sensor. When verifying the amount of the impact that is not less than a critical value set from the detected acceleration, the iris authentication system 1 may verify that there is a camera shake. In this case, the iris authentication system 1 may change the location of the circle indicating the shake of the camera in correspondence to the direction of change in the acceleration. If the change in the acceleration in the x-axis direction is sensed, the iris authentication system 1 may change and output the location of the circle in the x-axis direction. Where the shake is detected, the iris authentication system 1 may stop the time measurement by the timer 40 by a time period during which the shake is detected.

The iris authentication system 1 may map a preview image and a specific graphic object with respect to the eyes of the user and may allow the graphic object to react in response to the eye movement of the user.

Referring to FIG. 5F, the iris authentication system 1 may output a preview image 565 in which a preview image 561 and a graphic object 563 are composed. The iris authentication system 1 may process a graphic object and may compose the processed graphic object with a preview image. The iris authentication system 1 may determine the location, angle, and depth of the eye of the user by using the iris image. The iris authentication system 1 may perform one of resizing, clipping, rotating, and rendering on the graphic object based on the determined position, angle, and depth of the eye of the user. The iris authentication system 1 may compose at least one edited graphic object image with the preview image. The iris authentication system 1 may adjust the transparency of the original graphic object or the at least one edited graphic object and may overlay a graphic object, of which the transparency is adjusted, on the preview image. The iris authentication system 1 may output the overlaid preview image 565.

Referring to FIG. 5G, when the preview image is updated, the iris authentication system 1 may differently output the graphic object. For example, where the quality of the preview image is good and it is possible to recognize an iris, the iris authentication system 1 may output a first event 571 of the graphic object. The first event 571 may be an event that the graphic object faces in the front direction. If verifying that the user is too close to the screen, the iris authentication system 1 may output a second event of the graphic object, for example, a frowning eye 573. Where the iris authentication succeeds, the iris authentication system 1 may output a third event of a graphic object, for example, a heart sign 575.

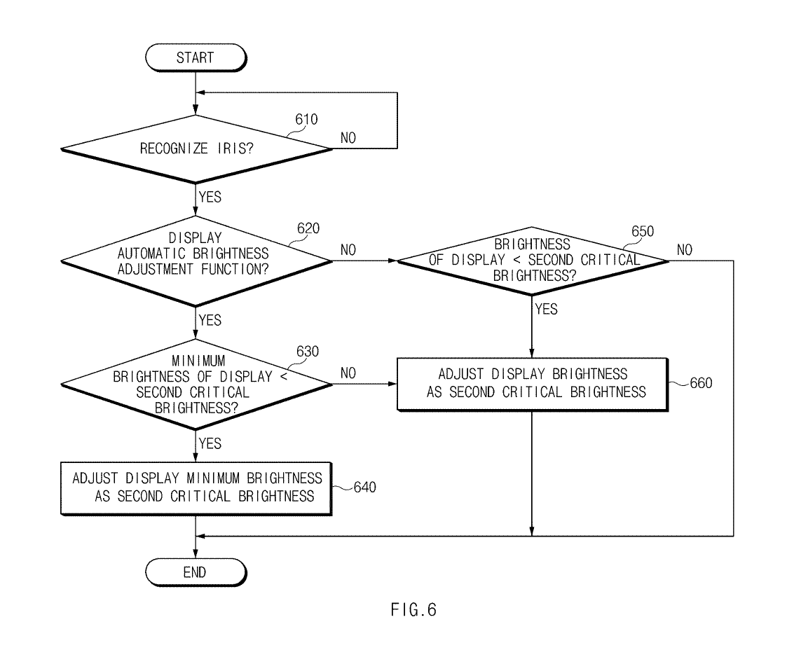

FIG. 6 is a flowchart illustrating an iris recognition method, according to an embodiment of the present disclosure.

If the iris recognition is started in operation 610, in operation 620, the iris authentication system 1 may determine whether the automatic brightness adjustment function for adjusting the brightness of a display is set to the display in response to the ambient illuminance.

In operation 630, the iris authentication system 1 may determine whether the minimum brightness of the automatic brightness adjustment range of the display is less than the critical brightness. The automatic brightness adjustment range of the display may be the brightness range of the display automatically adjusted depending on the ambient illuminance by executing the automatic brightness adjustment function of the display. The critical brightness may be set to be greater than or equal to the maximum value of the brightness at which a pupil enlarged due to lack of ambient light causes an iris recognition error.

In operation 640, if the minimum brightness of the automatic brightness adjustment range is less than the critical brightness, the iris authentication system 1 may change the minimum brightness of the display to the critical brightness. As a result, the third embodiment is directed to prevent the iris recognition error due to the lack of ambient light.

In operation 650, if a manual adjustment function of the display brightness is selected, the iris authentication system 1 may determine whether the display brightness is adjusted to be less than the critical brightness.

In operation 660, if the display brightness is adjusted to be less than the critical brightness, the iris authentication system 1 may increasingly adjust the display brightness to the critical brightness.

As such, even though the ambient illuminance is lowered, the display brightness may be maintained during the iris recognition to be greater than or equal to the critical brightness.

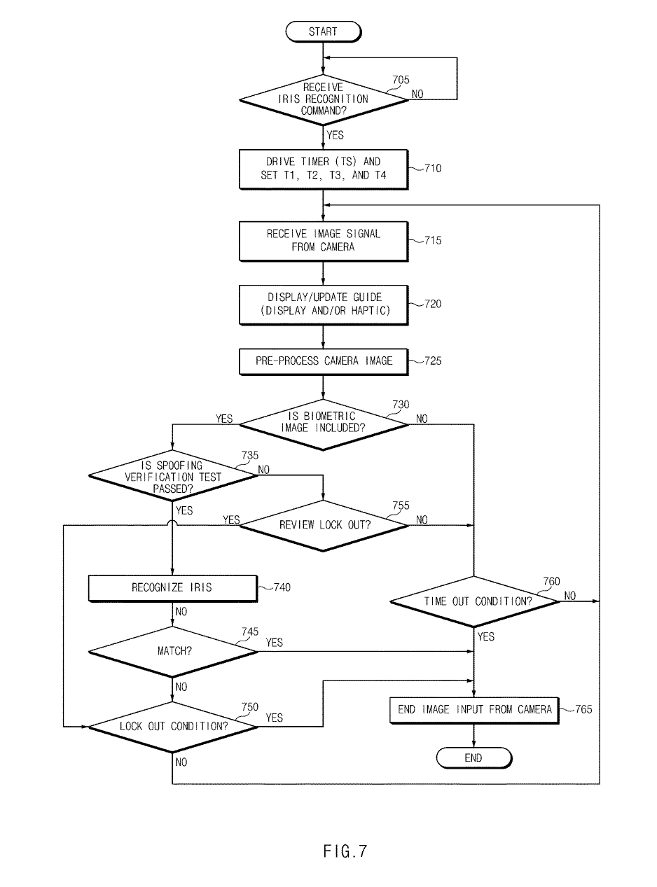

FIG. 7 is a flowchart illustrating an iris authentication method, according to an embodiment of the present disclosure.

Referring to FIG. 7, in operation 705, the iris authentication system 1 may receive an iris recognition command based on a user input.

In operation 710, the iris authentication system 1 may drive the timer 40 to verify a time for iris recognition or iris authentication. In operation 710, the iris authentication system 1 may further set critical time periods T1 to T4.

In operation 715, the iris authentication system 1 may receive an image frame from a camera.

In operation 720, the iris authentication system 1 may overlay a guide image on the preview image output during the iris recognition and may output the overlaid preview image. The controller 50 may further provide outputting of motor vibration during the iris recognition.

In operation 725, the iris authentication system 1 may detect one area from the image frame by pre-processing the image frame. The one area may be at least one of a face area, an eye area, and an iris area.

In operation 730, the iris authentication system 1 may determine whether a biometric image is included in the detected one area. The iris authentication system 1 may determine whether the face image is included in the face area, based on a face feature point. The iris authentication system 1 may determine whether a face image and an eye image are respectively included in a face area and an eye area, based on a feature point of a face and an eye. The iris authentication system 1 may determine whether a pupil and the iris image are included in the eye area, based on the feature point of the pupil and the iris. Where a fingerprint is recognized through a fingerprint recognition device, the iris authentication system 1 may determine that a biometric image is included therein.

In operation 735, the iris authentication system 1 may determine whether the iris image is tampered with, by executing the spoofing verification test. The iris authentication system 1 may distinguish between a biometric eye image and a printed eye image based on whether the variance value of the brightness distribution of the eye area corresponds to a value within a set critical distribution. The critical distribution may be experimentally determined from an average brightness distribution of a plurality of biometric eye images. The iris authentication system 1 may verify the spoofing through at least one of recognition of the speaker, verifying of a password, proximity sensing, measurement of a heart rate, and verifying of a user input corresponding to a set command.

In operation 740, if verifying that the spoofing verification test is passed, the iris authentication system 1 may recognize the iris in the eye area. The iris authentication system 1 may segment an iris area from the eye area and may extract an iris feature after normalization. The iris authentication system 1 may compare the extracted iris feature and the registered iris feature. If the comparison result indicates that the extracted iris feature is the same as the registered iris feature, the iris authentication system 1 may determine that iris authentication succeeds.

In operation 745, the iris authentication system 1 may determine whether the iris authentication succeeds, by using pattern matching during the set first critical time period.

In operation 750, if verifying that the iris authentication fails, the iris authentication system 1 may determine whether a lock out condition is satisfied. If the elapsed time Tc−Ts is not less than the first critical time period at the iris authentication failure, the iris authentication system 1 may determine that the lock out condition is satisfied. In operation 750, if verifying that the lock out condition is satisfied, the controller 50 may branch to operation 765. If the lock out condition is not satisfied, the controller 50 may branch to a time out verification routine (operation 760).

In operation 750, the iris authentication system 1 may change and set the first critical time period depending on the set condition. The iris authentication system 1 may differently set the first critical time period depending on the security level of the application used for the iris authentication. The iris authentication system 1 may differently set the first critical time period depending on the result of the spoofing verification test (e.g., the frequency of failure, the number of continuous failures, or the like). The iris authentication system 1 may set the first critical time period to be shorter as the image quality is worse. In operation 750, if the lock out condition is not satisfied, the iris authentication system 1 may not perform any specific processing.

In operation 755, if verifying that the eye image or the biometric eye image is not included in the eye image, the controller 50 may determine whether the review of the lock out is needed. Operation 755 may be skipped. If the specified lock out review is needed, the controller 50 may branch to the lock out verification routine (operation 760). If the specified lock out review is not needed, the controller 50 may branch to a time out verification routine (operation 750). As another example, the controller 50 may branch to a lock out verification routine (operation 750) or a timeout verification routine (operation 760) upon failure of the spoofing verification test that is depending on the security level of the application using the iris authentication. When an authentication function associated with an app such as a payment, health, medical, finance, and the like is executed, the controller 50 may branch a lock out verification routine (operation 750) if a spoofing verification test fails. The security level may be designated by a user, may be set by the manufacturer, and may include settings information of an app developer. If the spoofing verification test fails, the controller 50 may verify the number of failures of the spoofing verification test. Where the number of failures exceeds the specific number, the controller 50 may branch to a lock out verification routine (operation 750). If the spoofing verification test fails, the controller 50 may determine whether a specific time elapses. Where the specific time elapses, the controller 50 may branch to the lock out verification routine (operation 750). As such, if the failure of the spoofing verification test is one-time or if the failure frequency is less than the critical frequency, the image quality may be bad. Accordingly, the controller 50 may branch to the time out verification routine (operation 760) when the spoofing verification test fails. If the number of failures of the spoofing verification test is plural or if the failure frequency is greater than the critical frequency, the controller 50 may determine that attempt to disable security is made, and thus the controller 50 may branch to a lock out verification routine (operation 750) if the spoofing verification test fails. Where the spoofing verification test continuously fails the number of times greater than the specific number, the controller 50 may branch to a lock out verification routine (operation 750).

In operation 760, the authentication managing unit 30 may determine whether a time out condition is satisfied, if a biometric image or an actual biometric image is not included in the eye area.

In operation 765, in the case where the match condition, the time out condition, and the lock out condition are satisfied, the controller 50 may stop the transmission of an image from a camera to the iris recognizing unit 20. The controller 50 may perform setting of match, time out, and lock out and may perform at least one of outputting of a guide image and a vibration output corresponding to each state.

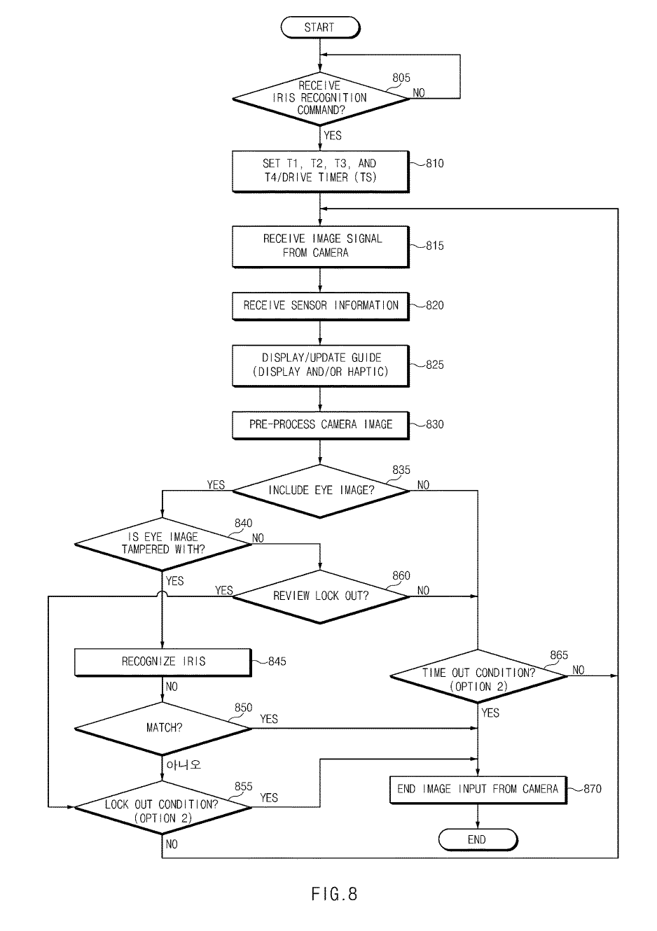

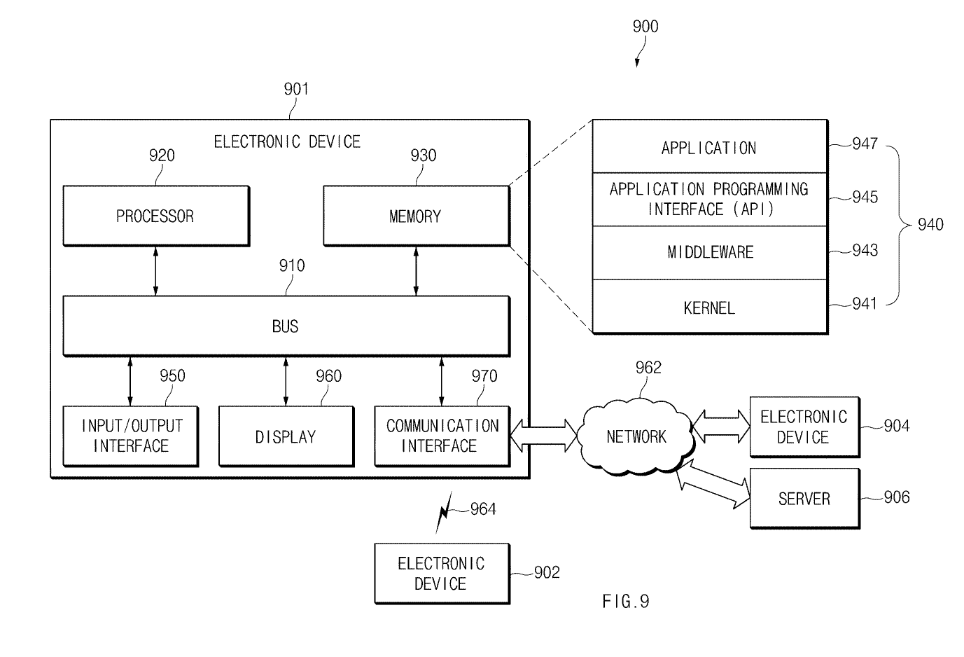

FIG. 8 is a flowchart illustrating an iris authentication method, according to an embodiment of the present disclosure.

Referring to FIG. 8, in operation 805, the authentication managing unit 30 may receive an iris recognition command in response to a user input.

In operation 810, the authentication managing unit 30 may drive the timer 40 and may set critical time periods T1 to T4.

In operation 815, the iris recognizing unit 20 may receive an image frame from a camera.

In operation 820, the controller 50 may receive information about at least one sensor of a movement sensing sensor, a distance sensing sensor, a location sensing sensor, and an illuminance sensor. The movement sensing sensor may include at least one of an acceleration sensor and a gyro sensor. The distance sensing sensor may include at least one of a stereo camera, and an infrared (IR) camera. The location sensing sensor may include at least one of a global positioning system (GPS) module, a wireless-fidelity (Wi-Fi) fingerprint, a communication processor (CP) positioning base, and a digital map. In operation 820, the controller 50 may further analyze at least one of brightness distribution of the preview image, an exposure change, a focus change, and a battery charge state.

Hereinafter, an example of critical time settings and performing of iris authentication of the iris authentication system 1 based on sensor information will be described.

If sensing the movement, which is greater than or equal to first critical movement, or verifying the approach within a critical distance, from the sensor information, the iris authentication system 1 may stop iris recognition. Where the iris authentication system 1 stops iris authentication, the iris authentication system 1 may recommend another authentication means (e.g., fingerprint) instead of iris authentication or may automatically switch to another authentication means.

If the movement is less than the critical movement after the iris authentication is interrupted or if being spaced beyond the critical distance, the iris authentication system 1 may resume iris authentication. The iris authentication system 1 may reset a critical time period. The iris authentication system 1 may increase first and second critical time periods by an interrupted time period. The iris authentication system 1 may prevent the elapsed time from being measured by stopping the timer 40 when the iris recognition is stopped.

If sensing movement that is less than first critical movement or is not less than second critical movement, the iris authentication system 1 may increase one of the first to fourth critical time periods. The second critical movement may be movement of magnitude that allows the iris recognition to be possible even though the movement of the user reduces the quality of the iris recognition.

If the illumination at a location of the user or the ambient illumination of the user is less than the critical illuminance, based on the sensor information of the illuminance sensor, the iris authentication system 1 may stop the iris authentication. Where the iris authentication system resumes the iris authentication after stopping the iris authentication, the iris authentication system 1 may change and set the critical time period or an elapsed time. If sensing a biometric image, the iris authentication system 1 may not perform a lock out even though spoofing is verified.

When it is verified to be the registered safety zone such as home or workplace, the iris authentication system 1 may set at least one of the critical time periods to be increased. The iris authentication system 1 may change and set at least one of the conditions during the iris authentication and the spoofing verification test in an area, where a payment service of a location based customer service (LBCS) is required, such as a store. The iris authentication system 1 may allow the lock out to occur more easily by relaxing the lock out condition. The iris authentication system 1 may further extend the lock out time in the area where a payment service is required. The iris authentication system 1 may relax the time out condition rather than the lock out time.

If verifying that a battery is sufficient, based on battery state information, the iris authentication system 1 may set the critical time period to be longer; otherwise, the iris authentication system 1 may set the critical time period to be shorter. If verifying that the battery is below the critical level, based on the battery state information, the iris authentication system 1 may recommend another authentication means that consumes relatively less power.

The iris authentication system 1 may evaluate the image quality in the pre-processing step of the preview image. If verifying that the image of the eye area is tampered with when the image quality is below the critical level, the iris authentication system 1 may determine whether the time out condition is satisfied instead of the lock-out condition. As such, it is possible to prevent unnecessary lock out from being set due to quality deterioration of the preview image.

In operation 825, the controller 50 may overlay a guide image on the received preview image output during the iris recognition and may output the overlaid preview image. The controller 50 may further provide outputting of motor vibration during the iris recognition.

In operation 830, the iris recognizing unit 20 may pre-process each image frame to extract an eye area.

In operation 835, the iris recognizing unit 20 may determine whether the actual eye image is included in the eye area. The iris recognizing unit 20 may determine whether the iris image is included in the eye area, by using the contrast of the eye area.

In operation 840, the iris recognizing unit 20 may determine whether the iris image is tampered with, by executing the spoofing verification test. The iris recognizing unit 20 may convert each pixel value of the eye area into a value in a frequency domain. The iris recognizing unit 20 may determine whether a biometric eye image is included in the eye image, based on whether the value in the frequency domain is included in the set critical band.

In operation 845, the iris recognizing unit 20 may segment an iris area from the eye area including the biometric eye image and may extract an iris feature through normalization.

In operation 850, the authentication managing unit 30 may determine whether the match is made, by using the result of pattern matching during the first critical time period set by the iris recognizing unit 20.

In operation 855, if verifying no-match, the controller 50 may determine whether a lock out condition is satisfied. In operation 855, if the lock out condition is not satisfied, the controller 50 may not perform any specific processing. In operation 855, the controller 50 may use a lock out time set based on the sensor information.

In operation 860, if the biometric eye image is not included in the eye image, the controller 50 may determine whether the review of the lock out is needed.

In operation 865, if an eye image is not included in an eye area or if the review of the lock out is not needed in a state where the eye image is not the biometric eye image, the authentication managing unit 30 may determine whether a time out condition is satisfied. In operation 865, the controller 50 may use the second critical time period set based on the sensor information.

In operation 870, the controller 50 may stop the transmission of an image from a camera to the iris recognizing unit 20 upon a time point of the match, the time out, and setting of the lock out. The controller 50 may perform setting of match, time out, and lock out and may perform at least one of outputting of a guide image corresponding to each state and a vibration output.

FIG. 9 is a block diagram illustrating an electronic device in a network environment, according to an embodiment of the present disclosure.

Referring to FIG. 9, the electronic device 901 includes a bus 910, a processor 920, a memory 930, an input/output interface 950, a display 960, and a communication interface 970. The electronic device 901 may not include at least one of the above-described elements or may further include other element(s).

The bus 910 may interconnect the above-described elements 910 to 970 and may be a circuit for conveying communications (e.g., a control message and/or data) among the above-described elements. The processor 920 may include one or more of a central processing units (CPUs), an application processor, or a communication processor (CP). The processor 920 may perform an arithmetic operation or data processing associated with control and/or communication of at least other elements of the electronic device 901.

The memory 930 may include a volatile and/or nonvolatile memory. The memory 930 may store instructions or data associated with at least one other component(s) of the electronic device 901. The memory 930 may store software and/or a program 940. The program 940 may include a kernel 941, a middleware 943, an application programming interface (API) 945, and/or an application program (application) 947. At least a part of the kernel 941, the middleware 943, or the API 945 may be called an OS. The kernel 941 may control or manage system resources (e.g., the bus 910, the processor 920, the memory 930, and the like) that are used to execute operations or functions of other programs (e.g., the middleware 943, the API 945, and the application 947). Furthermore, the kernel 941 may provide an interface that allows the middleware 943, the API 945, or the application 947 to access discrete elements of the electronic device 901 so as to control or manage system resources.

The middleware 943 may perform a mediation role such that the API 945 or the application 947 communicates with the kernel 941 to exchange data. Furthermore, the middleware 943 may process task requests received from the application 947 depending on a priority. The middleware 943 may assign the priority, which makes it possible to use a system resource (e.g., the bus 910, the processor 920, the memory 930, or the like) of the electronic device 901, to at least one of the application 947 and may process the task requests. The API 945 may be an interface through which the application 947 controls a function provided by the kernel 941 or the middleware 943, and may include at least one interface or function (e.g., an instruction) for a file control, a window control, image processing, a character control, or the like.

The input/output interface 950 may transfer an instruction or data input from a user or another external device, to other element(s) of the electronic device 901 or may output an instruction or data, received from other element(s) of the electronic device 901, to the user or the another external device.

The display 960 may include, for example, a liquid crystal display (LCD), an LED display, an organic LED (OLED) display, a microelectromechanical systems (MEMS) display, or an electronic paper display. The display 960 may display various kinds of content (e.g., a text, an image, a video, an icon, a symbol, and/or the like) to a user. The display 960 may include a touch screen and may receive a touch, gesture, proximity, or hovering input using an electronic pen or a part of a user's body. The communication interface 970 may establish communication between the electronic device 901 and a first external electronic device 902, a second external electronic device 904, or a server 906. The communication interface 970 may be connected to a network 962 through wireless communication or wired communication to communicate with the second external electronic device 904 or the server 906.

The wireless communication may include at least one of long term evolution (LTE), LTE Advance (LTE-A), code division multiple access (CDMA), wideband CDMA (WCDMA), universal mobile telecommunications system (UMTS), wireless broadband (WiBro), global system for mobile communications (GSM), or the like, as a cellular communication. The wireless communication may include at least one of Wi-Fi, Bluetooth (BT), BT low energy (BLE), Zigbee, near field communication (NFC), magnetic secure transmission (MST), radio frequency (RF), or a body area network (BAN). The wireless communication may include global navigation satellite system (GNSS). The GNSS may be one of GPS, a global navigation satellite system (Glonass), Beidou Navigation Satellite System (Beidou) or the European global satellite-based navigation system (Galileo). In this specification, “GPS” and “GNSS” may be interchangeably used. The wired communication may include at least one of a universal serial bus (USB), a high definition multimedia interface (HDMI), a recommended standard-232 (RS-232), a power line communication, or a plain old telephone service (POTS). The network 962 may include at least one of telecommunication networks, for example, a computer network (e.g., local area network (LAN) or wide area network (WAN)), an Internet, or a telephone network.

Each of the external first and second external electronic devices 902 and 904 may be a device of which the type is different from or the same as that of the electronic device 901. All or a part of operations that the electronic device 901 will perform may be executed by the electronic devices 902 and 904 or the server 906. Where the electronic device 901 executes any function or service automatically or in response to a request, the electronic device 901 may not perform the function or the service internally, but, alternatively/additionally, it may request at least a part of a function associated with the electronic device 901 at the electronic device 902 or 904 or the server 906. The electronic device 902 or 904 or the server 906 may execute the requested function or additional function and may transmit the execution result to the electronic device 901. The electronic device 901 may provide the requested function or service using the received result or may additionally process the received result to provide the requested function or service. To this end, cloud computing, distributed computing, or client-server computing may be used.

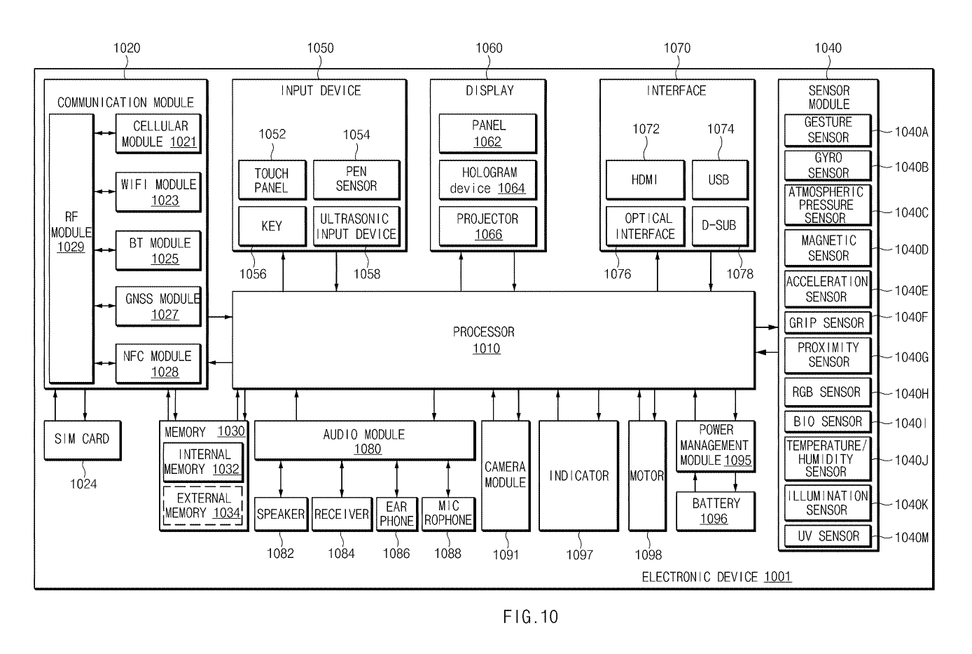

FIG. 10 illustrates a block diagram of an electronic device 1001, according to an embodiment of the present disclosure. The electronic device 1001 may include all or a part of the electronic device 901 illustrated in FIG. 9. The electronic device 1001 may include one or more processors (e.g., an AP) 1010, a communication module 1020, a subscriber identification module (SIM) 1024, a memory 1030, a sensor module 1040, an input device 1050, a display 1060, an interface 1070, an audio module 1080, a camera module 1091, a power management module 1095, a battery 1096, an indicator 1097, and a motor 1098. The processor 1010 may drive an OS or an application to control a plurality of hardware or software elements connected to the processor 1010 and may process and compute a variety of data. The processor 1010 may be implemented with an SoC. The processor 1010 may further include a graphic processing unit (GPU) and/or an image signal processor. The processor 1010 may include at least a part (e.g., a cellular module 1021) of elements illustrated in FIG. 10. The processor 1010 may load an instruction or data, which is received from at least one of other elements (e.g., a nonvolatile memory), into a volatile memory and process the loaded instruction or data. The processor 1010 may store a variety of data in the nonvolatile memory.

The communication module 1020 may be configured the same as or similar to the communication interface 970 of FIG. 9. The communication module 1020 may include the cellular module 1021, a Wi-Fi module 1023, a BT module 1025, a GNSS module 1027, a NFC module 1028, and an RF module 1029. The cellular module 1021 may provide voice communication, video communication, a character service, an Internet service, or the like over a communication network. The cellular module 1021 may perform discrimination and authentication of the electronic device 1001 within a communication network using the SIM 1024. The cellular module 1021 may perform at least a part of functions that the processor 1010 provides. The cellular module 1021 may include a CP. At least a part (e.g., two or more components) of the cellular module 1021, the Wi-Fi module 1023, the BT module 1025, the GNSS module 1027, or the NFC module 1028 may be included within one integrated circuit (IC) or an IC package.

The RF module 1029 may transmit and receive a communication signal (e.g., an RF signal). The RF module 1029 may include a transceiver, a power amplifier module (PAM), a frequency filter, a low noise amplifier (LNA), an antenna, or the like. At least one of the cellular module 1021, the Wi-Fi module 1023, the BT module 1025, the GNSS module 1027, or the NFC module 1028 may transmit and receive an RF signal through a separate RF module. The SIM 1024 may be an embedded SIM or a SIM card that includes a unique identify information (e.g., integrated circuit card identifier (ICCID)) or subscriber information (e.g., international mobile subscriber identity (IMSI)).

The memory 1030 may include an internal memory 1032 or an external memory 1034. The internal memory 1032 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory, or the like), a hard drive, or a solid state drive (SSD). The external memory 1034 may include a flash drive compact flash (CF), secure digital (SD), micro secure digital (Micro-SD), mini secure digital (Mini-SD), extreme digital (xD), a multimedia card (MMC), a memory stick, or the like. The external memory 1034 may be operatively or physically connected to the electronic device 1001 through various interfaces.

The sensor module 1040 940 may measure a physical quantity or may detect an operation state of the electronic device 1001. The sensor module 1040 may convert the measured or detected information to an electric signal. The sensor module 1040 may include at least one of a gesture sensor 1040A, a gyro sensor 1040B, a barometric pressure sensor 1040C, a magnetic sensor 1040D, an acceleration sensor 1040E, a grip sensor 1040F, a proximity sensor 1040G, a color sensor 1040H (e.g., red, green, blue (RGB) sensor), a biometric sensor 1040I, a temperature/humidity sensor 1040J, an illuminance sensor 1040K, or an UV sensor 1040M. Additionally or generally, the sensor module 1040 may further include, for example, an e-nose sensor, an electromyography (EMG) sensor, an electroencephalogram (EEG) sensor, an electrocardiogram (ECG) sensor, an IR sensor, an iris sensor, and/or a fingerprint sensor. The sensor module 1040 may further include a control circuit for controlling at least one or more sensors included therein. The electronic device 1001 may further include a processor which is a part of the processor 1010 or independent of the processor 1010 and is configured to control the sensor module 1040. The processor may control the sensor module 1040 while the processor 1010 remains in a sleep state.

The input device 1050 may include a touch panel 1052, a (digital) pen sensor 1054, a key 1056, or an ultrasonic input unit 1058. The touch panel 1052 may use at least one of capacitive, resistive, infrared, or ultrasonic detecting methods. Also, the touch panel 1052 may further include a control circuit. The touch panel 1052 may further include a tactile layer to provide a tactile reaction to a user.

The (digital) pen sensor 1054 may be a part of a touch panel or may include an additional sheet for recognition. The key 1056 may include a physical button, an optical key, a keypad, or the like. The ultrasonic input device 1058 may sense an ultrasonic signal, which is generated from an input device, through a microphone 1088 and may check data corresponding to the detected ultrasonic signal.

The display 1060 may include a panel 1062, a hologram device 1064, or a projector 1066, and/or a control circuit to control the panel 1062, the hologram device 1064, or the projector 1066. The panel 1062 may be implemented to be flexible, transparent or wearable. The panel 1062 and the touch panel 1052 may be integrated into one or more modules. The panel 1062 may include a pressure sensor (or a force sensor) which is capable of measuring an intensity of a pressure with respect to a touch of a user. The pressure sensor and the touch panel 1052 may be implemented as an integral or may be implemented with one or more sensors independent of the touch panel 1052. The hologram device 1064 may display a stereoscopic image in a space using a light interference phenomenon. The projector 1066 may project light onto a screen so as to display an image. The screen may be arranged in the inside or the outside of the electronic device 1001. The interface 1070 may include, for example, an HDMI 1072, a universal serial bus (USB) 1074, an optical interface 1076, or a D-subminiature (D-sub) 1078. The interface 1070 may be included in the communication interface 970 illustrated in FIG. 9. Additionally, the interface 1070 may include a mobile high definition link (MHL) interface, an SD card/multi-media card (MMC) interface, or an infrared data association (IrDA) standard interface.

The audio module 1080 may convert a sound and an electric signal in dual directions. At least a part of the audio module 1080 may be included in the input/output interface 950 illustrated in FIG. 9. The audio module 1080 may process sound information that is input or output through a speaker 1082, a receiver 1084, an earphone 1086, or the microphone 1088.

The camera module 1091 can be used for shooting a still image or a video and may include at least one image sensor (e.g., a front sensor or a rear sensor), a lens, an image signal processor (ISP), or a flash (e.g., an LED or a xenon lamp).

The power management module 1095 may manage power of the electronic device 1001. The power management module 1095 may include a power management integrated circuit (PMIC), a charger IC, or a battery gauge. The PMIC may have a wired charging method and/or a wireless charging method. The wireless charging method may include a magnetic resonance method, a magnetic induction method or an electromagnetic method and may further include an additional circuit, for example, a coil loop, a resonant circuit, or a rectifier, and the like. The battery gauge may measure a remaining capacity of the battery 1096 and a voltage, current or temperature thereof while the battery is charged. The battery 1096 may include, for example, a rechargeable battery and/or a solar battery.

The indicator 1097 may display a specific state of the electronic device 1001 or a part thereof (e.g., a processor 1010), such as a booting state, a message state, a charging state, and the like.

The motor 1098 may convert an electrical signal into a mechanical vibration and may generate the following effects: vibration, haptic, and the like. The electronic device 1001 may include a device (e.g., GPU) for supporting the mobile TV that processes media data according to the standards of digital multimedia broadcasting (DMB), digital video broadcasting (DVB), MediaFlo™, or the like.

Each of the above-mentioned elements may be configured with one or more components, and the names of the elements may be changed depending on the type of the electronic device. The electronic device 1001 may omit some elements or may further include additional elements. Furthermore, some of the elements of the electronic device 1001 may be combined with each other so as to form one entity, so that the functions of the elements may be performed in the same manner as before the combination.

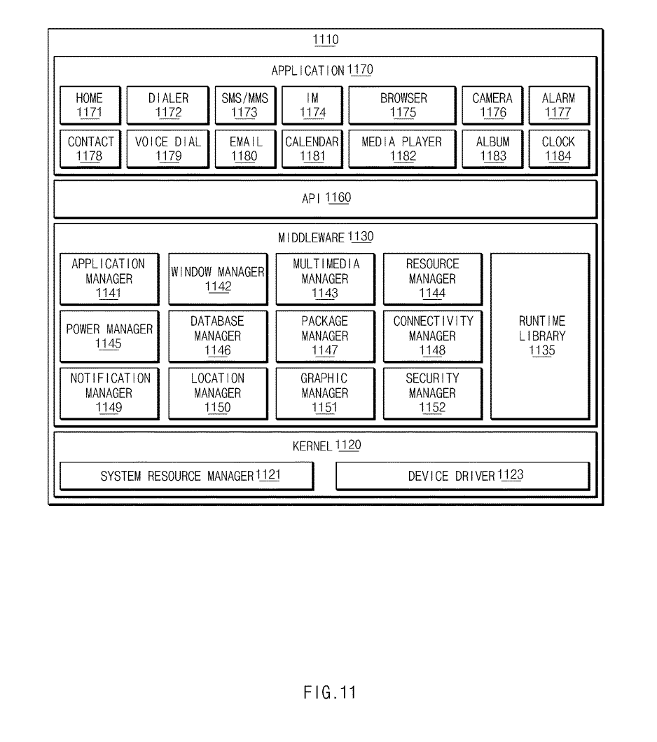

FIG. 11 is a block diagram of a program module, according to an embodiment of the present disclosure. A program module 1110 may include an OS to control resources associated with the electronic device 901, and/or diverse applications (e.g., the application 947) driven on the OS. The OS may include, Android™, iOS™, Windows™, Symbian™, Tizen™, or Bada™.

Referring to FIG. 11, the program module 1110 may include a kernel 1120, a middleware 1130, an application programming interface (API) 1160, and/or an application 1170. At least a part of the program module 1110 may be preloaded on an electronic device 901 or may be downloadable from the electronic device 902 or 904, the server 906, or the like.

The kernel 1120 may include a system resource manager 1121 and/or a device driver 1123. The system resource manager 1121 may perform control, allocation, or retrieval of system resources. The system resource manager 1121 may include a process managing part, a memory managing part, or a file system managing part. The device driver 1123 may include a display driver, a camera driver, a BT driver, a common memory driver, an USB driver, a keypad driver, a Wi-Fi driver, an audio driver, or an inter-process communication (IPC) driver. The middleware 1130 may provide a function that the application 1170 needs in common, or may provide diverse functions to the application 1170 through the API 1160 to allow the application 1170 to efficiently use limited system resources of the electronic device. The middleware 1130 may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, a security manager 1152, or an extended screen manager 1153.

The runtime library 1135 may include a library module that is used by a compiler to add a new function through a programming language while the application 1170 is being executed. The runtime library 1135 may perform input/output management, memory management, or arithmetic functions. The application manager 1141 may manage a life cycle of the application 1170. The window manager 1142 may manage a GUI resource that is used in a screen. The multimedia manager 1143 may identify a format necessary for playing media files and may perform encoding or decoding of media files by using a codec suitable for the format. The resource manager 1144 may manage source code of the application 1170 or a storage space. The power manager 1145 may manage a battery capacity or power and may provide power information for an operation of an electronic device. The power manager 1145 may operate with a basic input/output system (BIOS). The database manager 1146 may generate, search for, or modify database which is to be used in the application 1170. The package manager 1147 may install or update an application that is distributed in the form of package file.

The connectivity manager 1148 may manage wireless connection. The notification manager 1149 may provide an event such as arrival message, appointment, or proximity notification. The location manager 1150 may manage location information about an electronic device. The graphic manager 1151 may manage a graphic effect that is provided to a user, or manage a user interface relevant thereto. The security manager 1152 may provide system security or user authentication. The extended screen manager 1153 may determine an area of the display at which the graphic is displayed. The extended screen manager 1153 may manage information to be provided through the area of the display at which the graphic is displayed, a graphic effect or a user interface relevant thereto. The middleware 1130 may include a telephony manager for managing a voice or video call function of the electronic device or a middleware module which is capable of forming a combination of functions of the above-described elements. The middleware 1130 may provide a module specialized to each OS kind. The middleware 1130 may dynamically remove a part of the preexisting elements or may add new elements thereto. The API 1160 may be a set of programming functions and may be provided with another configuration which is variable depending on an OS. Where an OS is the Android™ or the iOS™, it may be permissible to provide one API set per platform. Where an OS is the Tizen™, it may be permissible to provide two or more API sets per platform.

The application 1170 may include an application such as a home application 1171, a dialer application 1172, an SMS/MMS application 1173, an instant message (IM) application 1174, a browser application 1175, a camera application 1176, an alarm application 1177, a contact application 1178, a voice dial application 1179, an e-mail application 1180, a calendar application 1181, a media player application 1182, an album application 1183, a watch application 1184, a health care application (e.g., measuring an exercise quantity, blood glucose, and the like), and offering of environment information (e.g., information of barometric pressure, humidity, temperature, or the like). The application 1170 may include an information exchange application to support information exchange between an electronic device and an external electronic device. The information exchanging application may include a notification relay application for transmitting specific information to the external electronic device, or a device management application for managing the external electronic device. The notification relay application may transmit notification information, which arise from other applications of the electronic device, to the external electronic device or may receive notification information from the external electronic device and provide the notification information to a user.

The device management application may install, delete, or update, for example, a function (e.g., turn-on/turn-off of the external electronic device itself (or a part of components) or adjustment of brightness (or resolution) of a display) of the external electronic device which communicates with the electronic device or an application running in the external electronic device. The application 1170 may include an application (e.g., a health care application of a mobile medical device) that is assigned in accordance with an attribute of the external electronic device. The application 1170 may include an application which is received from the external electronic device. At least a portion of the program module 1110 may be implemented (e.g., executed) by software, firmware, hardware (e.g., the processor 1010), or a combination of two or more thereof and may include modules, programs, routines, sets of instructions, processes, or the like for performing one or more functions.

An electronic device may include an iris recognizing unit that extracts an iris from one frame of a preview image and that performs iris authentication by extracting an iris feature and comparing the extracted iris feature and registered iris information and a processor that determines match, no-match, or an iris recognition error based on at least one of information of a process in which the iris recognizing unit performs the iris authentication a plurality of times during a first critical time period, and information of the result in which the iris recognizing unit performs the iris authentication a plurality of times during the first critical time period.

The iris recognizing unit may receive a plurality of frames of the preview image during specified recognition duration and selects the one frame, of which image quality is the best, from among the plurality of frames.

The iris recognizing unit may select the one frame by using at least one of brightness distribution, color distribution, an amount of AC component, a size, a shape, arrangement, and an angle of each of the plurality of frames.

The iris recognizing unit further may include a spoofing verifying unit that verifies a variance value of brightness distribution of each of frames of the preview image and to determine whether the preview image is tampered with, based on whether the verified variance value of the brightness distribution is within a specified critical range. The iris recognizing unit may extract the iris feature by using the one frame which passes a spoofing verification test of the spoofing verifying unit and which is not tampered with.

The electronic device may further include a spoofing verifying unit that determines whether the preview image is tampered with, through at least one of voice recognition, a password, proximity sensing, heart rate measurement, and a user input.

The processor may receive the information of the process about iris area detection, spoofing of an image, and quality of the image from the iris recognizing unit and distinguishes between the no-match and the iris recognition error based on the information of the process.

The electronic device may further include a display. The processor may blur at least part of the preview image and may output the blurred at least part of the preview image to at least part of the display.

The processor may perform at least one of a screen output and a vibration output, which correspond to the iris recognition error, if the processor verifies the iris recognition error from the information of the process before the first critical time period expires.

The electronic device may further include a display. The processor may compare a brightness value of each of pixels of the preview image with at least one critical brightness, may classify each of the pixels of the preview image into a plurality of brightness steps based on the comparison result, may convert a value of each of the classified pixels of each of the brightness steps into a value of a color of a specified similar series associated with each of the brightness steps, and may output the color to at least part of the display.

The electronic device may further include a display. The processor may tone down a pupil area of the preview image and may output the toned-down pupil area to at least part of the display.

The electronic device may further include a display. The processor may normalize brightness of at least part of pixels of the preview image based on a distance from a user, and may output the preview image including the normalized at least part of pixels to at least part of the display.

The electronic device may further include a display. The processor may verify at least one of a degree of opening of an eye, a location of the eye, and a shake of the eye based on at least one of image quality information and sensor information from the iris recognizing unit, may overlay a guide image for guiding at least one of adjustment of the degree of opening of the eye, adjustment of the location of the eye, and shake caution on the preview image based on the verified result, and may output the overlaid guide image to at least part of the display.

The processor may determine whether there is a specified factor for disturbing the extraction of the iris feature from at least one of a shaking, a distance from a user and an ambient illuminance, and may adjust the first critical time period if the specified factor is present.

The processor may control brightness of a display to be greater than or equal to set critical brightness, if an iris authentication function for determining the match, the no-match, or the iris recognition error is executed.

The electronic device may further include a display. The processor may compose the preview image with a graphic object and may output the composed preview image in at least part of the display. The graphic object may perform an event of the graphic object mapped to at least one of an iris authentication process, the match, the no-match, or the iris recognition error.

An iris authentication method by at least one processor may include extracting an iris feature from one frame of a preview image, comparing the extracted iris feature with registered iris information, determining match, no match, or an iris recognition error by using the comparison result and intermediate processing information during a first critical time period, and displaying the match, the no-match, or the iris recognition error.

An electronic device may include a housing, a touchscreen display exposed through one surface of the housing, a light source disposed on the one surface of the housing, an imaging device that photographs an iris of a user by using at least a portion of light, which is emitted from the light source and is reflected from a face of the user, and disposed on the one surface of the housing, a processor electrically connected with the touchscreen display, the light source, and the imaging device, and at least one memory electrically connected with the processor and storing a reference iris image. The memory may store instructions that, when executed, cause the processor to allow the light source to emit light, to obtain a first plurality of images by using the imaging device during a first time period, while the light is emitted, to compare the reference iris image with each of objects included in the first plurality of images, and to count the number of failures of iris authentication as one no-match, if the comparison result indicates that the reference iris image is not the same as each of objects included in two or more images among the first plurality of images.

The instructions may cause the processor to count the number of failures of the iris authentication as one no-match, even though the comparison result indicates that the reference iris image is not the same as an object, which is included in one image, of the first a plurality of images.

The instructions may cause the processor to allow the light source to emit light, to obtain a second plurality of images by using the imaging device during a second time period after the first time period, while the light is emitted, to compare the reference iris image with each of objects included in the second plurality of images, and to increase the number of failures of the iris authentication by one, if the comparison result indicates that the reference iris image is not the same as each of objects included in two or more images among the second plurality of images.

The instructions may cause the processor to disable the iris authentication during a selected time period, if the number of failures of the iris authentication reaches the selected number.

The conventional issue that the lock out occurs in an extremely short time period may be improved in the iris authentication process. The success rate and ease of iris authentication may be improved by providing the user with an error occurring in the authentication process.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. An electronic device comprising:
an iris recognizing unit that extracts an iris area from one frame of a preview image and performs iris authentication by comparing a feature of the iris area with registered iris information; and
a processor that determines a match, a no-match, or an iris recognition error based on one of a result of the iris authentication during the first critical time period and an amount of times that the iris authentication is performed.

2. The electronic device of claim 1, wherein the iris recognizing unit receives a plurality of frames of the preview image during a specified recognition duration and selects the one frame among the plurality of frames.

3. The electronic device of claim 2, wherein the iris recognizing unit selects the one frame by using at least one of brightness distribution, color distribution, a frequency range of spatial frequency, a size, a shape, an arrangement, and an angle of each of the plurality of frames.

4. The electronic device of claim 1, wherein the iris recognizing unit further includes:
a verifying unit that verifies a variance value of brightness distribution of frames of the preview image and determines whether the preview image is damaged, based on whether the verified variance value of the brightness distribution is within a specified range, and
wherein the iris recognizing unit extracts the feature of the iris area using the one frame which passes a verification test performed by the verifying unit and which is not damaged.

5. The electronic device of claim 1, further comprising:
a verifying unit configured to determine whether the preview image is damaged based on one of voice recognition, a password, proximity sensing, heart rate measurement, and a user input.

6. The electronic device of claim 1, wherein the processor receives information relating to the detection of the iris area, damage of an image, and quality of the image from the iris recognizing unit and distinguishes between the no-match and the iris recognition error based on the received information.

7. The electronic device of claim 1, further comprising:
a display,
wherein the processor blurs a part of the preview image and outputs the preview image including the blurred part to a portion of the display.

8. The electronic device of claim 1, wherein the processor performs one of a screen output and a vibration output, which correspond to the iris recognition error, if the processor verifies the iris recognition error before a second critical time period expires.

9. The electronic device of claim 1, further comprising:
a display,
wherein the processor compares a brightness value of each pixel of the preview image with at least one critical brightness, classifies each the pixels of the preview image into a plurality of brightness steps based on the comparison result, converts a value of each of the classified pixels of each of the brightness steps into a value of a color associated with each of the brightness steps, and outputs the color to a portion of the display.

10. The electronic device of claim 1, further comprising:
a display,
wherein the processor tones down a pupil area of the preview image and outputs the preview image including the toned-down pupil area to at least part of the display.

11. The electronic device of claim 1, further comprising:
a display,
wherein the processor normalizes brightness of part of pixels of the preview image based on a distance from a user, and outputs the preview image including the normalized part of pixels to at least part of the display.

12. The electronic device of claim 1, further comprising:
a display,
wherein the processor verifies at least one of a degree of opening of an eye, a location of the eye, and a shake of the eye based on at least one of image quality information and sensor information from the iris recognizing unit, overlays a guide image for guiding at least one of adjustment of the degree of opening of the eye, adjustment of the location of the eye, and shake caution on the preview image based on the verified result, and outputs the overlaid guide image to at least part of the display.

13. The electronic device of claim 1, wherein the processor determines whether there is a specified factor for disturbing the extraction of the feature from one of a shaking, a distance from a user and an ambient illuminance, and adjusts the first critical time period if the specified factor is present.

14. The electronic device of claim 1, wherein the processor controls brightness of a display of the electronic device to be greater than or equal to set brightness, if a function of the iris authentication is executed.

15. The electronic device of claim 1, further comprising:
a display,
wherein the processor composes the preview image with a graphic object and outputs the composed preview image in a portion of the display, and
wherein the graphic object performs an event corresponding to one of a process of the iris authentication, the match, the no-match, or the iris recognition error.

16. An iris authentication method, the method comprising:
extracting an iris area from one frame of a preview image;
performing iris authentication by comparing a feature of the iris area with registered iris information;
determining a match, a no-match, or an iris recognition error based on one of a result of the iris authentication during the first critical time period and an amount of times that the iris authentication is performed; and
displaying the match, the no-match, or the iris recognition error.

17. An electronic device comprising:
a housing:
a touchscreen display exposed through one surface of the housing;
a light source disposed on the one surface of the housing;
an imaging device that photographs an iris of a user by using a portion of light, which is emitted from the light source and is reflected from a face of the user, and disposed on the one surface of the housing;
a processor electrically connected with the touchscreen display, the light source, and the imaging device; and
at least one memory electrically connected with the processor to store a reference iris image,
wherein the memory stores instructions that, when executed, cause the processor to:
allow the light source to emit light;
obtain a first plurality of images by using the imaging device during a first time period, while the light is emitted;
compare the reference iris image with an object included in the first plurality of images; and
count the number of failures of iris authentication as one no-match, if the comparison result indicates that the reference iris image is not the same for the object included in at least two images among the first plurality of images.

18. The electronic device of claim 17, wherein the instructions cause the processor to:
count the number of failures of the iris authentication as one no-match, even though the comparison result indicates that the reference iris image is not the same for the object, which is included in one image, of the first a plurality of images.

19. The electronic device of claim 17, wherein the instructions cause the processor to:
allow the light source to emit light;
obtain a second plurality of images by using the imaging device during a second time period after the first time period, while the light is emitted;
compare the reference iris image with an object included in the second plurality of images; and
increase the number of failures of the iris authentication by one, if the comparison result indicates that the reference iris image is not the same for the object included in at least two images among the second plurality of images.

20. The electronic device of claim 19, wherein the instructions cause the processor to:
disable the iris authentication during a selected time period, if the number of failures of the iris authentication reaches a selected number.
